(19) United States
(12) Patent Application Publication
(10) Pub. No.: US 2022/0341721 A1
(43) Pub. Date: Oct. 27, 2022

(54) ARRANGEMENT AND METHOD FOR MONITORING AT LEAST ONE DISTANCE

(71) Applicant: KOHERENT OY, Helsinki (FI)

(72) Inventor: Kari LEPPÄNEN, Helsinki (FI)

(21) Appl. No.: 17/764,327

(22) PCT Filed: Oct. 2, 2020
(86) PCT No.: PCT/FI2020/050651

§ 371 Date: Mar. 28, 2022

(30) Foreign Application Priority Data
Oct. 3, 2019 (FI) 20195844

(51) Int. Cl. G01B 7/02; G01S 13/08

(52) U.S. Cl. CPC G01B 7/023; G01S 13/08; G01B 7/16

(57) ABSTRACT

An arrangement (100, 200, 300) for monitoring of at least one distance between antenna units, the arrangement comprising at least two antenna units (104, 106, 116, 118, 136, 138), each antenna unit being associated with a radio unit (108, 110), the arrangement additionally comprising at least one radio unit being associated with at least one of the at least two antenna units, and at least one processor. The two antenna units are configured to placed at at least first and second locations, the arrangement being configured to execute at least two measurement cycles wherein during each measurement cycle the arrangement is configured to transmit at least one signal via antenna units one at a time and determine phase information for said signals being received by remaining antenna units. Distance variables determined based on the phase information are used to determine a change in distance between antenna units between measurement cycles.

### TECHNICAL FIELD OF THE INVENTION

The invention is related to measurement in general. More specifically, the invention is related to an arrangement and method for monitoring at least one distance utilizing at least one first antenna unit and at least one second antenna unit.

### BACKGROUND OF THE INVENTION

Distance measurements are important in various fields and applications. Accuracy of distance measurements may also play a vital role in many cases, while reliability and/or cost-effectiveness of the measurement methods and apparatuses are preferably considered. With existing solutions for distance measurements, either accuracy, reliability, or cost suffers when one of these is improved.

In particular, monitoring a distance or determining a change in one or more distances may be advantageous in many cases. Potential applications include e.g. tracking of position or monitoring of structures.

In one application, monitoring of structures, such as bridges or roofs, is important for e.g. safety and maintenance relating to the structures and gaining knowledge about changes in the structures over time is valuable when considering the overall cost of the structure over its lifetime.

Typically, structures are monitored using optical strain gauges or vibration sensors. These types of methods do not give direct information about the deformation of the structure. One may obtain information indicating that a change or movement has occurred in the form of the structure, but this type of information has limited use.

In addition to offering restricted possibilities for gaining detailed knowledge on the type of changes or deformations occurring in structures, methods in the current state of the art are expensive and difficult to use or install. In particular, e.g. installation of strain gauges is demanding, they often require also installation of optical fibers, and this type of equipment is prone to failures.

Free space laser measurements can measure changes in distances and e.g. deformations of structures quite accurately but are not suitable for large-scale monitoring because of high price, difficult installation with accurate pointing requirements, need for maintenance, and susceptibility to weather conditions (fog, rain, snow, air turbulence).

Due to the drawbacks of many of the available methods for determining distances, in particular for the use of monitoring structures, these are used mostly in massive, critical, and expensive structures such as bridges, but less in e.g. industry.

If a method for monitoring distances in an accurate and inexpensive manner would be available, this would lead to new possibilities of using monitoring methods where current methods are not feasible due to inaccuracy or cost.

### SUMMARY OF THE INVENTION

A purpose of the invention is to alleviate at least some of the problems relating to the known prior art. In accordance with one aspect of the present invention, an arrangement is provided for monitoring of at least one distance, the arrangement comprising at least two antenna units, each antenna unit being associated with a radio unit, the arrangement additionally comprising at least one radio unit being associated with at least one of the at least two antenna units, and at least one processor. The two antenna units are configured to be placed at at least first and second locations, the arrangement being configured to execute at least two measurement cycles wherein during each measurement cycle the arrangement is configured to
transmit at least a first signal via at least one first antenna unit,
receive the at least first signal at at least one second antenna unit,
determine at least first phase information related to the first signal, said first phase information being indicative of a phase of the received first signal with respect to a local oscillator of the radio unit with which the at least one second antenna unit is associated,
transmit at least one response signal via the at least one second antenna unit, wherein the response signal essentially corresponds to the first signal,
receive the at least one response signal at the at least one first antenna unit,
determine at least response phase information related to the response signal, said response phase information being indicative of a phase of the received response signal with respect to a local oscillator of the radio unit with which the at least one first antenna unit is associated, to obtain at least one pair of antenna units which have mutually transmitted and received at least one signal among each other so that two-way phase information is determined with respect to at least one signal that is sent by a first antenna unit in the pair of antenna units and received by the second antenna unit in the pair of antenna units and at least one signal that is sent by the second antenna unit in the pair of antenna units and received by the first antenna unit in the pair of antenna units, and
determine at least one distance variable, said distance variable being indicative of a distance between the antenna units in the at least one pair of antenna units, the distance variable optionally being indicative of sums of the two-way phase information obtained for each pair of antenna units, an at least first distance variable being indicative of a distance between the first and second antenna units, the first distance variable optionally being indicative of a sum of the first phase information and the response phase information.

Based on the determined at least one distance variable at each measurement cycle, the arrangement is additionally configured to determine if the at least one distance variable indicates a change in the distance between the antenna units in at least one pair of antenna units.

According to one other aspect, a method is provided according to the independent claim 15, a computer program according to independent claim 18, and a use according to independent claim 19.

Having regard to the utility of the present invention, according to an embodiment, the present invention may provide an arrangement and method for monitoring a distance where even small changes in the distance may be detected more accurately, more directly and/or in a simpler and/or more cost-efficient way than in the prior art.

Monitoring of a distance may refer to determining if a change in a distance occurs or determination of a change in distance (determination of a change in distance in terms of a numerical measurement, such as one in metric units).

Monitoring of a distance may refer to repeatedly determining if a distance changes.

Determining a change in distance between antenna units may also refer to determining a change in distance of zero if the distance between antenna units has not changed.

One embodiment of an arrangement may be used for monitoring deformation of a physical structure, where the at least two antenna units are configured to be operatively coupled to at least one physical structure at at least first and second locations of the physical structure.

Through the use of antenna units associated with radio units, at least one distance or baseline between pairs of antenna units may be determined by utilizing one or more distance variables which may advantageously be determined as one or more sums of detected phase information. The sum of detected phase information may be used to obtain data that is indicative of a distance between two antenna units in a pair of antenna units, where at least some effects related local oscillators of associated radio units and/or components in the signal path, such as filters, amplifiers and mixers, may be eliminated.

Through embodiments of the invention, an arrangement and method may be easy to install and inexpensive to implement. Distances of small or large scale may be monitored at desired time intervals and to desired precision.

The materials or components used in an arrangement may be relatively easy to acquire at low cost. Compared to e.g. free space laser measurements, installation is simplified, as in particular omni-directional antennas can be used so that there may be no need for accurate pointing at installation phase.

The present invention offers possibilities of gaining knowledge relating to changes in distance, such as deformations in structures at an early stage. As even small changes in the form of a structure may be detected essentially as soon as they have occurred or shortly thereafter, future actions, such as e.g. maintenance operations, may be planned in good time so that further deterioration of the structure may be avoided or reduced.

Compared to prior art solutions, an arrangement disclosed herein may be more robust and stable, requiring less maintenance and being more durable and long-lasting in its operation.

An arrangement may be less sensitive to environmental conditions than existing solutions where e.g. snow may make distance measurements less reliable. Especially if used at low frequencies (e.g. less than 20 GHz, preferably less than 10 GHz, more preferably less than 6 GHz), an arrangement may be practically immune to weather conditions or dust and may still be accurate to changes in distance that are above e.g. 0.5 mm or 0.1 mm.

An arrangement may be simple to operate and may be implemented essentially without use of cables, as for instance solar panels or batteries may be used for power.

In embodiments of the invention, one or more distances between two or more antenna units may be determined and monitored over time. A change in distance between two antenna units of even as small as e.g. 0.1 mm may be detected, while in the prior art, changes of distances so small may not be able to be measured over ranges of tens or even hundreds of meters, leading to the present arrangement and method possibly being more accurate and versatile than such prior art solutions.

Because of the advantageous features of the present invention, related to e.g. inexpensiveness, robustness, and accuracy, possibilities of monitoring of distances may be offered in fields or applications where such monitoring has not been feasible before.

Possible application areas related to the invention in embodiments where structures are monitored may be e.g. bridges, roofs, skyscrapers or other buildings, wind turbines and their blades, smoke stacks, masts, dams, cranes, underground tunnels, pipelines and storage tanks, support structures of heavy machinery, or alignment of long axles (for instance turbine-generator combinations).

In some embodiments, the arrangement may comprise a plurality of antenna units, each antenna unit being associated with a radio unit, wherein during each measurement cycle, the arrangement may be configured to
transmit at least a first signal via at least one first antenna unit,
receive the at least first signal at the remaining non-transmitting antenna units,
determine, respectively for each non-transmitting antenna unit receiving the first signal, at least first phase information related to the first signal, said first phase information being indicative of a phase of the received first signal with respect to a local oscillator of the radio unit with which the receiving non-transmitting antenna unit is associated,
transmit a plurality of response signals via at least a portion of the antenna units that have not transmitted the first signal, wherein the response signals essentially correspond to the first signal, wherein the response signals are transmitted consecutively by one antenna unit at a time, via at least a portion of the antenna units that have not transmitted the first signal,
receive the plurality of response signals at at least a portion of the remaining non-transmitting antenna units,
determine, respectively for each non-transmitting antenna unit receiving the response signals, at least response phase information related to each of the received response signals, said response phase information being indicative of a phase of the received response signal with respect to a local oscillator of the radio unit with which the remaining non-transmitting antenna units receiving the response signal are associated with,
transmit response signals, receive response signals, and determine phase information to obtain a plurality of pairs of antenna units, which have mutually transmitted and received at least one signal among each other so that two-way phase information is determined with respect to at least one signal that is sent/transmitted by a first antenna unit in the pair of antenna units and received by the second antenna unit in the pair of antenna units and at least one signal that is sent by the second antenna unit in the pair of antenna units and received by the first antenna unit in the pair of antenna units, and
determine at least a plurality of distance variables, each distance variable being indicative of a distance between the antenna units in each pair of antenna units, the distance variables optionally being indicative of sums of the two-way phase information obtained for each pair of antenna units.

When a plurality of antenna units are used, a plurality of antenna units may transmit and receive signals and a plurality of pairs of antenna units are thus obtained which have transmitted and received at least one signal among themselves to obtain at least two-way phase information. Here, relative distances between a plurality of antenna units may be monitored, leading to a more versatile arrangement than those known in the prior art.

With embodiments of the present invention where a plurality of antenna units are employed, utilizing N transmissions one may determine or monitor N(N−1)/2 distances. In the prior art, in order to determine a distance between two antenna units has required two transmissions per link (between two antenna units), such that for determination of N(N−1)/2 distances, a total of N(N−1), i.e. nearly N² transmissions have been needed.

In embodiments of the invention, a plurality (e.g. five or more) antenna units may be utilized, and the determined distances and changes therein may be used to determine relative positions between the antenna units. Three-dimensional changes in the form of the tree-dimensional configuration of the antenna units may be determined.

A change in one or more distances may be monitored essentially continuously by an embodiment of an arrangement configured to execute measurement cycles at predetermined time intervals.

Determining of distance variable and determining of change in distance is preferably carried out at each measurement cycle, yet the determining of either of these does not necessarily have to be determined at every measurement cycle.

By determining, through consecutive measurements of at least one distance between antenna units (through consecutive determining of at least one distance variable and comparison of the determined distance variable between measurement cycles), an arrangement may determine how the distance changes over time and thus e.g. monitor a physical structure with which the antenna units are coupled and observe if a deformation in the physical structure occurs.

In an embodiment of the invention, an arrangement may be configured to essentially continuously monitor at least one distance and if a change in distance between antenna units in at least one pair of antenna units is indicated according to predetermined criteria, an action may be initiated. The predetermined criteria may be related e.g. to at least one distance changing by an amount that exceeds a threshold or at least one distance changing in some predetermined time interval by an amount that exceeds some threshold value, for instance. Predetermined criteria may in some cases be related to one or more changes in form or configuration of at least one physical structure that may be determined based on the determined one or more distance variables.

An action to be initiated may e.g. be providing an indication to a user of the arrangement, such indication e.g. comprising information such as that a distance between the at least first and second antenna units in at least one pair of antenna units has changed and/or that a form of a physical structure has changed.

An action to be initiated may additionally or alternatively be related to a change in the operation of the arrangement, such as changing a signal and/or changing a time interval between subsequent measurement cycles.

In one embodiment, each of the transmitting antenna units may transmit at least one signal within a predetermined time slot. The transmitting of the signals by the transmitting antenna units may be done in a predetermined order. Here, the transmissions may be carried out so that transmissions occur in subsequent time slots so that no empty time slots are left between the transmissions. The transmissions and time slots may also be proportioned such that there is less than a selected “empty” time interval between the end of a transmission and the start of a subsequent time slot where a subsequent antenna unit will start its transmission. A time interval between the end of a transmission and the start of a subsequent transmission may be less than less than 50 μs, preferably less than 20 μs, such as less than 16 μs.

With embodiments of the invention where transmitting antenna units transmit at least one signal within a predetermined time slot and in predetermined order, the subsequent providing of a compact transmission signal may be advantageously used in combination with e.g. WiFi networks. With the present invention, a wireless channel for the transmissions only needs to be reserved once per measurement cycle. This feature may enable compatibility of the present invention with networks such as the aforementioned WiFi.

Without transmissions occurring in predetermined time slots and predetermined order, a measurement cycle could take longer and an unknown time duration to complete. This is because one measurement cycle could not be carried out effectually as a single transmission in a wireless channel that only needs to compete for the channel once as defined e.g. in ETSI EN 301 893 (the standard specification regulating 5 GHz WiFi transmissions). The channel would have to be competed for by each transmitting antenna unit separately during transmission, which could cause arbitrarily long measurement sequences if the channel gets occupied by other users between the transmissions. Such a delay could easily lead to a situation where the channel changes more than half a wavelength between the sequences (causing N*2⁻π ambiguity in the phase sum), possibly making the measurement useless. Even if the change in distance is slow, this would also mean that the local oscillators of the antenna units would have to be very high in quality to maintain phase coherence between the different antenna units during the longer and indeterministic measurement interval. With the present solution, however, oscillators of lower quality may be utilized in this regard, and the arrangement may be implemented at lower cost.

The first antenna unit may be a master unit and the remaining radio units may be slave units. The master unit may be an antenna unit that is configured to transmit the first signal.

In an embodiment, the master unit may be configured to check before transmission of the first signal whether a radio channel is free for transmission and if the channel is free, the at least first signal is transmitted, said transmitting not being executed if the channel is not free.

An arrangement may advantageously utilize radio bands/channels that require listen-before-talk functionality, as a master unit may check if the radio channel is free before transmission of the first signal and if yes, then the measurement cycle of the arrangement may be carried on with and the radio channel may then be reserved by the arrangement for at least the one measurement cycle. If it is determined that a radio channel is not free, then the first signal may not be transmitted and the measurement cycle may be aborted or cancelled without any signals being transmitted, while the master unit or first antenna unit may then wait for a predetermined time between measurement cycles and then at the next measurement cycle, once more check if the radio band is free and then carry on with transmission of the first signal to initiate a measurement cycle if the radio band is free.

In some embodiments comprising a master antenna unit and one or more slave antenna units, the slave units may be configured to determine, before transmitting of a signal in a given measurement cycle, if a previous antenna unit in the predetermined order of antenna units has transmitted a signal in the measurement cycle, and if yes, transmit their respective signal, while the signal is not transmitted (waiting for a full measurement cycle) if it is determined that the previous antenna unit has not transmitted a signal, i.e., if a valid measurement signal is not received.

In embodiments of an arrangement, the at least first antenna unit may send a time synchronization signal that is received by the at least remaining radio antenna units before sending of the first signal. Through the time synchronization, the antenna units may conduct transmission of signals in synchronized manner having regard to time slots associated with a predetermined order in which signals are to be transmitted, especially in embodiments where the time between subsequent measurement cycles is relatively long, such as over one minute.

In some embodiments, an arrangement may comprise one or more radio units wherein at least one radio unit is associated with at least two antenna units. In such arrangements, materials and monetary resources related to radio units may be saved compared to situations where a radio unit is always associated with only one antenna unit. An arrangement may be simpler to manufacture and/or implement, possibly being also simpler to maintain and/or repair.

In some embodiments of an arrangement comprising a plurality of radio units, one or more of the radio units may be associated with at least two antenna units. One or more of the radio units may be associated with more than two antenna units.

In one advantageous embodiment, an arrangement may additionally be configured to determine two-way calibration data for at least one of the pairs of antenna units, wherein the two-way calibration data is indicative of a self-measurement signal received at a transmitting antenna unit during transmission of a signal, for each of the two antenna units in the pair of antenna units. At least one distance variable may then be determined as being indicative of a difference between the sum of the two-way phase information obtained for each pair of antenna units and the sum of the two-way calibration data.

Two-way calibration data may comprise calibration phase information for each of the antenna units in the pair of antenna units, said calibration phase information being indicative of a phase of a self-measurement signal with respect to the local oscillator of a radio unit with which the transmitting antenna unit is associated.

When calibration data is obtained and used in determination of at least one distance variable, the distance variable may take into account in the determined phase information effects or errors resulting from components in the signal path, such as filters, amplifiers, mixers and/or transmission lines. A distance variable may then be more accurately indicative of the distance between antenna units and errors resulting from the configuration of the arrangement may advantageously be essentially eliminated or at least reduced.

In yet one embodiment of an arrangement, at least information related to the determined distance variables may be received at one or more remote processors. The data received at the remote processor may be stored therein and may for instance be accessed by a user of the arrangement.

In one embodiment, the processor/local processor of an arrangement may be relatively simple and configured to execute only simple operations related to e.g. receiving of phase information and determination of distance variables, while a remote processor may then advantageously be a more complex computing arrangement, through which more complicated data processing and/or storage may be implemented. For instance, it may be a remote processor that utilizes the determined distance variables to resolve more detailed information related to the one or more distances between antenna units and/or e.g. predict how the one or more determined distances between antenna units may change in the future and/or implications of the determined or predicted distances.

One embodiment of an arrangement may additionally be configured to communicate data and multiplex the data and the signals transmitted via the antenna units in time or frequency domain. The data may preferably comprise at least the determined phase information.

The exemplary embodiments presented in this text are not to be interpreted to pose limitations to the applicability of the appended claims. The verb “to comprise” is used in this text as an open limitation that does not exclude the existence of unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

The presented considerations concerning the various embodiments of the arrangement may be flexibly applied to the embodiments of the method mutatis mutandis, and vice versa, as being appreciated by a skilled person.

### BRIEF DESCRIPTION OF THE DRAWINGS

Next the invention will be described in greater detail with reference to exemplary embodiments in accordance with the accompanying drawings, in which:

FIG. 1 shows an exemplary arrangement according to one embodiment of the invention,

FIG. 2 illustrates one other exemplary arrangement according to one embodiment of the invention,

FIG. 3 shows one more exemplary arrangement according to one embodiment of the invention,

FIG. 4 shows allocation of time slots in measurement cycles,

FIG. 5 shows a first and second antenna unit and associated radio units

FIG. 6 gives an exemplary radio unit that may be used in one embodiment of an arrangement,

FIG. 7 gives one other exemplary radio unit that may be used in one embodiment of an arrangement,

FIG. 8 illustrates a portion of an exemplary antenna unit that may be used in one embodiment of an arrangement,

FIG. 9 illustrates schematically how an arrangement may be used in connection with a physical structure,

FIG. 10 shows a flow chart of a method according to an exemplary embodiment of the invention,

FIG. 11 shows a flow chart of a portion of a method according to an exemplary embodiment of the invention, and

FIG. 12 shows one other flow chart of a portion of a method according to an exemplary embodiment of the invention.

### DETAILED DESCRIPTION

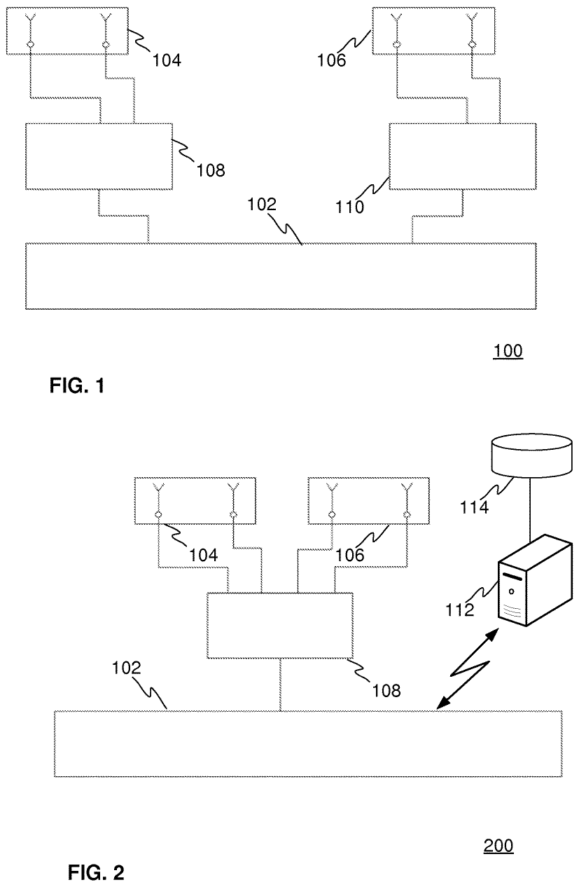

FIG. 1 shows one embodiment of an arrangement 100 according to the present invention. The arrangement 100 comprises at least one processor 102 and at least two antenna units 104, 106, each antenna unit being associated with a radio unit. An antenna unit 104, 106 may be comprised in a radio unit or be coupled to a radio unit via e.g. cables.

In FIG. 1, a first antenna unit 104 is associated with a first radio unit 108 and a second antenna unit 106 is associated with a second radio unit 110. In different embodiments of an arrangement 100, different numbers of antenna units and radio units may be utilized, of which some examples will be introduced hereinafter.

The processor 102 may be a controller unit that is external to the radio units 108, 110, and may be implemented as a microprocessor unit or provided as a part of a larger computing unit such as a personal computer. In some embodiments, the processor 102 may be comprised in or be considered to be part of a radio unit 108, 110.

The processor 102 may be configured to control the radio units and/or antenna units comprised in an arrangement 100. The processor 102 may additionally or alternatively be configured to receive data from the antenna units and/or radio units comprised in an arrangement 100 in a wired (e.g. Ethernet) or wireless (e.g. WLAN) manner.

The processor 102 and radio units 108, 110 may be powered using for instance power-over-Ethernet (PoE), direct mains supply, batteries, solar panels, or mechanical generators (e.g. in wind turbine blades).

The radio units 108, 110, or at least the associated antenna units 104, 106 are configured to be capable of being placed at at least first and second locations. The suitable locations may be defined by the intended use.

In one embodiment where the arrangement is used to monitor deformation of physical structures, the radio units 108, 110, or at least the associated antenna units 104, 106 may be configured to be capable of being operatively coupled to a physical structure that is to be monitored. The coupling to the physical structure may be carried out through utilizing any type of coupling means, such as pins, screws, magnetic materials, or adhesives. Such coupling means may also be utilized in other use case scenarios.

The first antenna unit 104 may be configured to be operatively coupled with a physical structure at a first location while the second antenna unit 106 may be configured to be operatively coupled with a physical structure at a second location. The first and second locations may physically reside on the same physical structure or they may reside on different physical structures.

The coupling or operative coupling of the antenna units at first, second etc. locations of a physical structure refer here to coupling at locations such that a desired distance may be effectively monitored to be able to monitor the physical structure. In this text, it may be said that an antenna unit is operatively coupled to a location on a physical structure, but the location may be a location that is physically exterior to the physical structure, such as on some other structure.

An arrangement may comprise e.g. third and fourth antenna units etc. being configured to be placed at third and fourth locations, such as third and fourth locations of a physical structure.

In embodiments involving physical structures and their deformation monitoring, it may be preferable if at least a first location physically resides on the physical structure that is to be monitored and at least a second location resides either physically on the physical structure to be monitored or on some other external physical structure, yet so that the second location may preferably be assumed to be stationary in order to be used as a reference point for movements.

For instance, the physical structure to be monitored may be a bridge, and a first location may reside at a center of the bridge structure while a second location may reside e.g. at a location where the bridge is connected to some other structure or a starting location of the bridge, or the second location may e.g. be a ground location. A physical structure to be monitored may be a roof/ceiling, wherein the first location may reside on e.g. an inner surface of a ceiling and a second location may be e.g. on a floor structure. A physical structure may be on a bearing of an axle, whereby the first and second locations may be on one or more physical structures defining the axle alignment.

In embodiments where the arrangement 100 is used for tracking position(s), a first location may be associated with a target that is to be tracked, while a second location may reside at a location that is stationary or which has a known position. Also relative tracking of a plurality of targets may be carried out. A first location may reside in connection with a first target, a second location may reside in connection with a second target, and e.g. a third location may reside in connection with a third target or with a stationary or known location.

The two or more locations with which the two or more antenna units 104, 106 are configured to be coupled with are preferably selected so that there is at least one antenna unit which is in line of sight with at least one other antenna unit.

The arrangement 100 may be configured to execute at least two measurement cycles, wherein during each measurement cycle, at least one first signal is transmitted and received and at least one response signal is transmitted and received. Through the transmitted and received signals, at least a first distance variable may be determined, as will be disclosed below. The at least first distance variable may be indicative of a distance between a first and second antenna unit, whereby through performing a plurality of measurement cycles, changes in this distance may be detected.

Through monitoring changes in the at least one distance, monitoring of changes occurring in a physical structure or tracking of a relative position of one or more targets may be possible.

Signals transmitted during one measurement cycle are preferably equivalent or essentially correspond to each other. Signals may, however, vary between measurement cycles depending on the embodiment. For instance, signals transmitted during different measurement cycles may comprise differing frequencies (while all signals still transmitted during one measurement cycle have essentially the same frequency).

A measurement cycle of e.g. an arrangement 100 according to FIG. 1 is given below.

The first antenna unit 104 is configured to transmit a first signal. Said first signal may be a radiofrequency (RF) signal such as an unmodulated RF signal (i.e. a sinusoid), a comb of RF sinusoids spanning a frequency range, or an RF signal modulated by any known (complex) sequence.

The frequency of the first signal and subsequent signals may for instance be under 10 GHz. An arrangement 100 is however not limited to any frequency range. For example, 5 GHz-60 GHz may be utilized. In cases of high frequency, the quality of a local oscillator of the radio units may be a factor that should be considered. To be able to utilize e.g. 60 GHz frequencies, for instance a 5PPB oscillator may be of sufficient quality.

The duration of the first signal (and subsequent signals) may for instance be between 10 and 10 000 μs depending on e.g. the length of the distances that are to be measured, the time intervals between measurement cycles, and/or the quality of local oscillators comprised in the radio units 108, 110. A duration of a signal may for instance be between 50 μs-5000 μs, or between 50 μs-1000 μs, such as about 100 μs.

The first signal is received at the at least second antenna unit 106. Based on the received first signal, at least first phase information related to the first signal is determined, said first phase information being indicative of a phase of the received first signal with respect to a local oscillator of the radio unit with which the at least one second antenna unit is associated, here the second radio unit 110.

The determining of the phase information may be carried out at the receiving radio unit 110.

The second antenna unit 106 is configured to transmit a response signal. The response signal may be equivalent to the first signal or essentially correspond to the first signal at least in frequency. The response signal is received at the first antenna unit 104. Based on the received response signal, at least response phase information is determined, said response phase information being indicative of a phase of the received response signal with respect to a local oscillator of the radio unit with which the at least one first antenna unit is associated, here the first radio unit 104.

The first antenna unit 104 and second antenna unit 106, having mutually transmitted and received at least one signal among each other, constitute a pair of antenna units for which two-way phase information is determined (i.e. phase information is determined regarding the first signal received by the second antenna unit 106 and response phase information is determined regarding the response signal received at or by the first antenna unit 104).

In addition to determining phase information, also amplitude information may be determined in some embodiments. For example, both phase information and amplitude information may be determined at a receiving radio unit upon receiving a first and/or response signal.

The determined phase information (and/or amplitude information, for instance) may be received by the processor 102. The phase information may be used to determine (by the processor 102) a distance variable that is indicative of a distance between the first and second antenna units 104, 106. The distance variable may advantageously be determined by utilizing a sum of the determined first phase information and the response phase information.

In some embodiments where amplitude information is determined, the amplitude information may be used to estimate the reliability of the distance data (a distance variable or indication of a determined distance). For example, a temporary obstruction in the light of sight between the antenna units may be detected and the distance data marked invalid for the affected time period.

After the above procedures that may make up one measurement cycle, the arrangement 100 may be configured to execute at least one second measurement cycle with essentially similar procedures.

An arrangement may be configured to execute measurement cycles at predetermined time intervals. The predetermined time interval may be e.g. in the range of seconds to several hours. For instance, a measurement cycle may be initiated once per minute or once per hour. The predetermined time interval between measurement cycles may also be different between different measurement cycles.

Through repeated measurement cycles, the distance variable may be repeatedly determined. The obtained values for the distance variable may be compared with each other to determine if a change in the distance between the first and second antenna units has changed. For instance, distance variables determined at consecutive or at least temporally spaced apart measurement cycles may be compared with each other.

The distance between antenna units 104, 106 may be monitored over time.

Through observing changes occurring in the distance, e.g. a physical structure may be monitored over time, so that changes or deformations in the physical structure may be detected.

An arrangement 100 may be configured to indicate, e.g. via at least one computer-readable output, to a user of the arrangement observations regarding the at least one monitored distance.

A user of an arrangement 100 may for instance be kept informed of the state of a physical structure at predetermined time intervals or an arrangement may be configured to initiate an action (such as providing an indication to a user) if a change in a distance is detected. An action may be initiated according to predetermined criteria, such as if a change in distance is detected that exceeds a certain threshold.

Indicating to a user of an arrangement that a change in a distance has occurred may be advantageous for instance in monitoring of objects in general. A user could e.g. be informed if an object has been misplaced.

FIG. 2 shows one other embodiment of an arrangement 200. Here, (in addition to at least one processor 102) the arrangement 200 comprises a first antenna unit 104 and a second antenna unit 106, which are both associated with a first radio unit 108. In arrangements where one or more radio units 104, 106 are associated with two or more antenna units 104, 106 each, radio units may be saved.

The operation of the arrangement 200 of FIG. 2 is similar to that of the arrangement 100 of FIG. 1 with the exception that only one radio unit 108 is required.

In FIG. 2, also a remote processor 112 is depicted (of course any arrangement, such as that of FIG. 1 could also comprise the remote processor 112). An arrangement 100, 200 may then also comprise a remote processor 112 with which the (local) processor 102 may be in communication utilizing wired or wireless communication, e.g. via WLAN (wireless local area network) or WAN (wide area network) such as a mobile data network or a fixed network. The remote processor 112 may refer to at least one processor which may be accessed through cloud computing, and/or the remote processor 112 may refer to at least one virtual processor comprised in a plurality of locations which may be configured to execute procedures through parallel processing means.

The remote processor 112 may be configured to receive at least data indicative of the determined distance variable(s), the three-dimensional relative positions of the antenna units, and/or any changes of such variables. A remote processor 112 may comprise e.g. at least one database 114 for storing information.

One remote processor 112 may be associated with one or more arrangements 100, 200. For example, one arrangement may be configured to monitor one physical structure and another arrangement may be configured to monitor another physical structure or e.g. track relative position of one or more targets, while both arrangements 100, 200 may be configured to be in communication with a remote processor 112.

A remote processor 112 may in some embodiments be configured to conduct at least a portion of the procedures explained hereinbefore, e.g. determining if a change in distance between antenna units has occurred, and/or initiating an action.

A remote processor 112 may additionally or alternatively be configured to utilize the obtained and/or determined information to determine or monitor changes in the three-dimensional form of a physical structure or three-dimensional mutual configuration of antenna units (at least in arrangements where a sufficient number, such as e.g. 5 or more, antenna units are utilized). Also, a (local) processor 102 may in other embodiments be configured to carry out such determination, monitoring, or tracking.

Monitoring of changes in distance may be used to determine a timing or type of maintenance or other procedure that should be performed in relation to monitored distances. For instance, this may be particularly advantageous in monitoring of physical structures. For example, an arrangement 100, 200 may determine that a certain type of deformation has occurred that indicates that a certain type of maintenance procedure should be performed in order to retain the physical structure in a state that ensures e.g. efficient or safe performance.

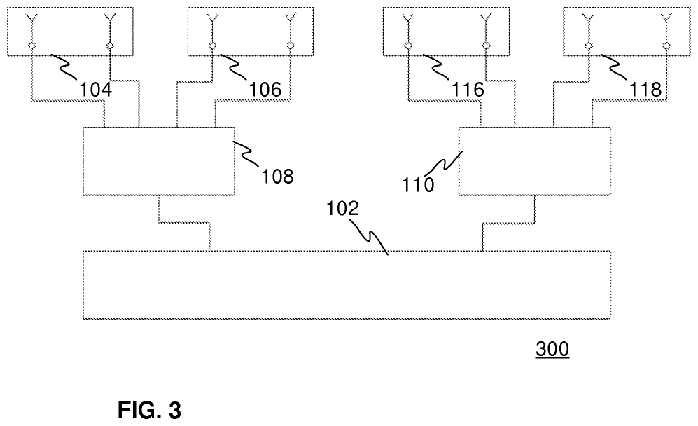

Yet one more exemplary embodiment of an arrangement 300 is shown in FIG. 3 (with possible remote processor 112 omitted from the figure). As before, at least one processor 102 and first and second antenna units 104 and 106 are comprised in the arrangement 300. The arrangement 300 of FIG. 3 comprises a first radio unit 108 with which the first and second antenna units 104 and 106 are associated, the arrangement 300 additionally comprising at least a second radio unit 110, which is associated with a third antenna unit 116 and a fourth antenna unit 118.

In one measurement cycle that is executed by the arrangement of FIG. 3, the measurement cycle may comprise at least the following (not given in any specific temporal order, with e.g. receiving of signals occurring essentially simultaneously):
the first antenna unit 104 sends a first signal
the second antenna unit 106 receives the first signal
the third antenna unit 116 receives the first signal
the fourth antenna unit 118 receives the first signal
the first radio unit 108 determines first phase information for the second antenna unit 106, being indicative of a phase of the received first signal at the second antenna unit 106 with respect to a local oscillator of the first radio unit 108
the second radio unit 110 determines first phase information for the third antenna unit 116, being indicative of a phase of the received first signal at the third antenna unit 116 with respect to a local oscillator of the second radio unit 110
the second radio unit 110 determines first phase information for the fourth antenna unit 118, being indicative of a phase of the received first signal at the fourth antenna unit 116 with respect to a local oscillator of the second radio unit 110
the second antenna unit 106 sends a first response signal
the first antenna unit 104 receives the first response signal
the third antenna unit 116 receives the first response signal
the fourth antenna unit 118 receives the first response signal
the first radio unit 108 determines first response information for the first antenna unit 104, being indicative of a phase of the received first response signal at the first antenna unit 104 with respect to a local oscillator of the first radio unit 108
the second radio unit 110 determines first response phase information for the third antenna unit 116, being indicative of a phase of the received first response signal at the third antenna unit 116 with respect to a local oscillator of the second radio unit 110
the second radio unit 110 determines first response phase information for the fourth antenna unit 118, being indicative of a phase of the received first response signal at the fourth antenna unit 118 with respect to a local oscillator of the second radio unit 110
the third antenna unit 116 sends a second response signal
the first antenna unit 104 receives the second response signal
the second antenna unit 106 receives the second response signal
the fourth antenna unit 118 receives the second response signal
the first radio unit 108 determines second response information for the first antenna unit 104, being indicative of a phase of the received second response signal at the first antenna unit 104 with respect to a local oscillator of the first radio unit 108
the first radio unit 108 determines second response phase information for the second antenna unit 106, being indicative of a phase of the received second response signal at the second antenna unit 106 with respect to a local oscillator of the first radio unit 108
the second radio unit 110 determines second response phase information for the fourth antenna unit 118, being indicative of a phase of the received second response signal at the fourth antenna unit 118 with respect to a local oscillator of the second radio unit 110
the fourth antenna unit 118 sends a third response signal
the first antenna unit 104 receives the third response signal
the second antenna unit 106 receives the third response signal
the third antenna unit 116 receives the third response signal
the first radio unit 108 determines third response information for the first antenna unit 104, being indicative of a phase of the received third response signal at the first antenna unit 104 with respect to a local oscillator of the first radio unit 108
the first radio unit 108 determines third response phase information for the second antenna unit 106, being indicative of a phase of the received third response signal at the second antenna unit 106 with respect to a local oscillator of the first radio unit 108
the second radio unit 110 determines third response phase information for the third antenna unit 116, being indicative of a phase of the received third response signal at the third antenna unit 116 with respect to a local oscillator of the second radio unit 110
a first distance variable is determined that is indicative of a sum of the first phase information for the second antenna unit 106 and the first response information for the first antenna unit 104
a second distance variable is determined that is indicative of a sum of the first phase information for the third antenna unit 116 and the second response information for the first antenna unit 104
a third distance variable is determined that is indicative of a sum of the first phase information for the fourth antenna unit 118 and the third response information for the first antenna unit 104
a fourth distance variable is determined that is indicative of a sum of the first response phase information for the third antenna unit 116 and the second response phase information for the second antenna unit 106
a fifth distance variable is determined that is indicative of a sum of the first response phase information for the fourth antenna unit 118 and the third response phase information for the second antenna unit 106
a sixth distance variable is determined that is indicative of a sum of the second response phase information for the fourth antenna unit 118 and the third response phase information for the third antenna unit 116.

With the above measurement cycle, six pairs of antenna units are obtained which have mutually transmitted and received at least one signal among each other so that two-way phase information is obtained. The two-way phase information may then be utilized e.g. in a sum to obtain a distance variable that is indicative of a distance between the antenna units in a pair of antenna units.

The above measurement cycle may be executed by the arrangement 300 at least two times to determine at least two values for each of the determined distance variables. A change in one or more of the determined distances may then be observed and actions may be initiated accordingly, if the arrangement 300 thus determines.

In some embodiments of an arrangement 100, 200, 300, a first antenna unit 104 is a master antenna unit, while the other antenna units 106, 116, 118 are slave units. The master antenna unit may be configured to check before each transmission of the first signal (at the beginning of each measurement cycle), if the channel in which the transmission is to occur if free for transmission. If the channel is deemed free, the master unit may send the first signal. If the channel is deemed occupied, the current measurement cycle that was to be initiated may be aborted and the master antenna unit 104 may wait until the beginning of a subsequent measurement cycle and yet once more detect if the intended channel is free for transmission.

A master antenna unit 104 or a first antenna unit 104 may in yet one more embodiment of an arrangement be configured to transmit a time synchronization signal that is received by the remaining antenna units in an arrangement 100, 200, 300 at least before transmission of the first signal.

One of the radio units of an arrangement, preferably the one serving or being associated with the master antenna unit 104, may be referred to as a reference radio unit.

In embodiments of the arrangement, second and possible remaining antenna units that may be slave units may be configured to detect, before transmission of any response signal, if the previous antenna unit in the measurement cycle has transmitted its respective signal. If it is determined that the previous antenna unit in the measurement cycle has not transmitted a signal, the antenna unit may not transmit its own signal. If it is determined that the previous antenna unit in the measurement cycle has transmitted a signal, the antenna unit may then transmit its own signal.

In different embodiments of an arrangement 100, 200, 300, all of the received signals are not necessarily used to determine phase information or distance variables, as in some cases only a portion of the distances that could in theory be determined or monitored are in effect determined.

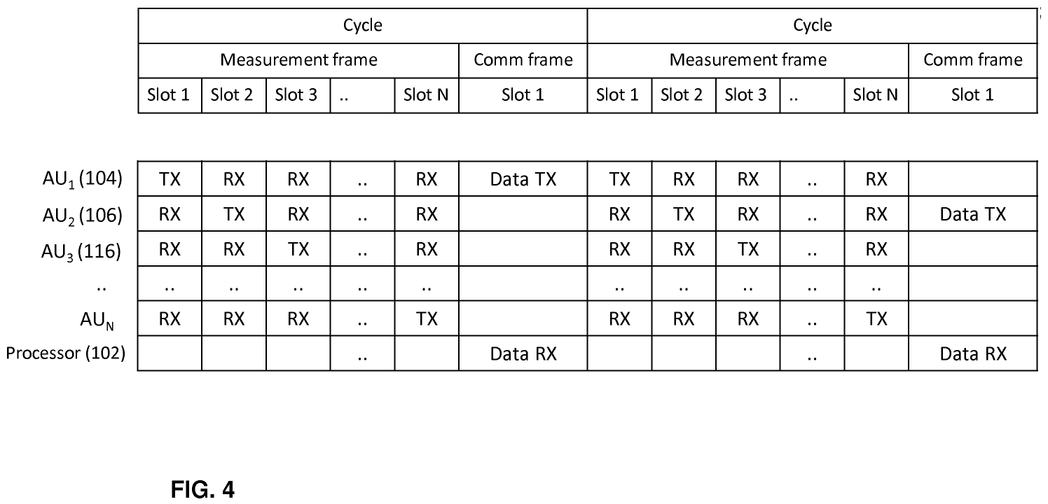

FIG. 4 illustrates how time slots may be allocated in measurement cycles for transmission and receiving of signals and communication of data in an arrangement 100, 200, 300. AU₁, AU₂, . . . AU_{N} represent the first and second to N^{th} antenna units comprised in the arrangement, with TX and RX referring to transmit and receive.

One measurement cycle may comprise at least one measurement frame (with N measurement slots) and at least one communication frame (with one or more communication slots). During the measurement frame, the antenna units AU₁-AU_{N} may transmit their respective signals separately, each in their own time slot which is allocated to them, while the other antenna units receive this signal. The measurement cycle starts with the first antenna unit AU₁ 104 or master antenna unit transmitting the first signal (after possibly having determined that the transmission channel is available for transmission), which received by the other antenna units in the arrangement (or at least a portion thereof). The measurement cycle then continues with transmission of response signals via the remaining, possibly slave, antenna units of the arrangement (or at least a portion thereof) which are configured to transmit a signal, in a predetermined order.

During a communication frame, signals, measured/determined data, or any other data may be transmitted to a (local) processor 102 and/or a remote processor 112. At least one data communication may be transmitted and multiplexed with the measurement signals transmitted by the antenna units in time or frequency domain. The at least one data communication may comprise at least the determined phase information. A data communication may additionally or alternatively comprise any other information. An arrangement 100, 200, 300 may thus serve as a measurement arrangement and a communication network simultaneously.

The required time synchronization accuracy should be better than one tenth of the slot length (i.e. the duration of a signal, which can be e.g. about 100 μs in one use case scenario) in order to prevent overlapping transmissions.

It should be noted that time slots in measurement cycles can also be allocated such that a plurality of measurement frames occur before a communication frame.

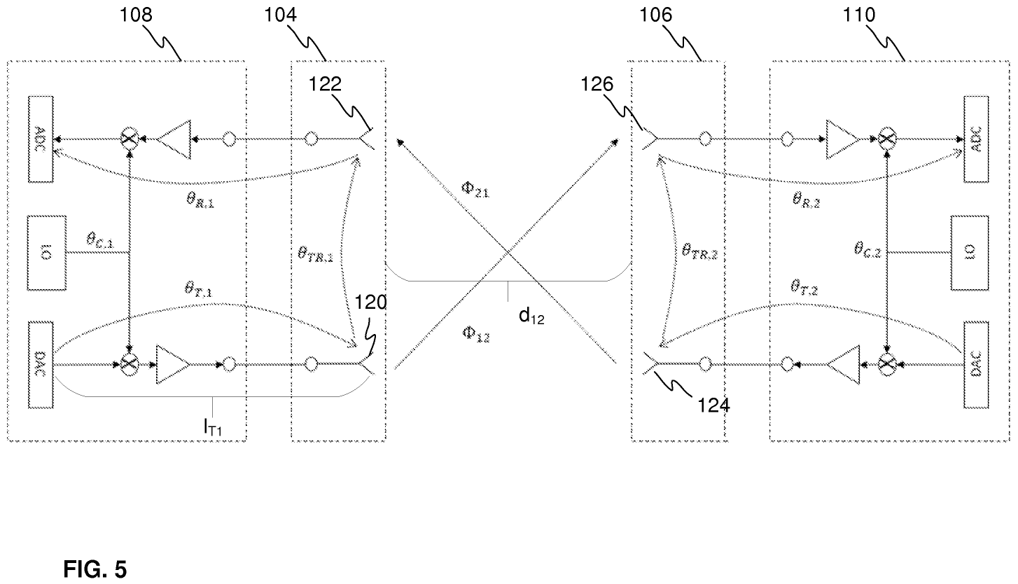

FIG. 5 exhibits schematically how phase information related to signals that are transmitted and received between two antenna units 104, 106 in a pair of antenna units that mutually transmit and receive at least one signal among each other may be used to determine a distance variable. In the embodiment of FIG. 5, the distance and/or change in distance between a first antenna unit 104 and a second antenna unit 106 may be determined, and this distance may then be monitored.

In the embodiment of FIG. 5, the first antenna unit 104 is associated with a first radio unit 108 and the second antenna unit 106 is associated with a second radio unit 110. Similar considerations apply also to other embodiments involving differing numbers of antenna units and/or radio units.

The first antenna unit 104 may comprise a transmission antenna (TX₁) 120 and a receiving antenna (RX₁) 122, while the second antenna unit 106 may comprise a transmission antenna (TX₂) 124 and a receiving antenna (RX₂) 126. The first antenna unit 104 may transmit a first signal via its transmission antenna 120 in the time slot that is allocated to it in a measurement cycle, and the first signal may be received at the receiving antenna 126 of the second antenna unit 106.

As may be easily understood by the skilled person, distances may be defined in terms of phase lengths, i.e., phase shifts that occur in a signal (e.g. sine wave) as it traverses a certain length.

Assuming that the transmitting first antenna unit 104 transmits the first signal with zero phase with respect to its local clock/oscillator (LO), the measured/determined phase φ₁₂ of the signal received at the second antenna unit 106 (at the receiving antenna 126) may be determined by (as also easily seen from FIG. 5):

φ₁₂=⊖_{C,1}−⊖_{T,1}−φ₁₂−⊖_{R,2}−⊖_{C,2}. (1)

⊖_{C,1} and ⊖_{C,2} are the phases of the local oscillators of the first and second radio units 108, 110, respectively (at the time of transmission for the first radio unit 108). 012 is the geometric phase corresponding to the distance or baseline or connecting geometric line between the transmission antenna 120 of the first antenna unit 104 and the receiving antenna 126 of the second antenna unit 106. ⊖_{T,1} and ⊖_{R,2} are the transmit and receive branch phase lengths corresponding to the first antenna unit 104 and second antenna unit 106, respectively (with phase length referring here to the phase shift that occurs in a signal traversing along a certain distance).

The transmit and receive branch phase lengths, e.g. ⊖_{T,1} and ⊖_{R,2}, comprise the phase lengths that are due to the physical lengths of the transmit and receive branches of the antenna units and the associated radio units, comprising also possible cable lengths. For instance, as seen in FIG. 5, the phase length ⊖_{T,1} corresponds to the length of transmission branch of the first radio unit 108 from the transmission antenna 120 to the digital-analog converter (DAC), shown as I_{T1}.

Accordingly, during a time slot in the measurement cycle where the second antenna unit may transmit a response signal (possibly after determining that the first signal has been transmitted), the second antenna unit 106 may transmit the response signal via its transmission antenna 124 and the response signal may be received at the receiving antenna 122 of the first antenna unit 104.

Yet, assuming that the second antenna unit 106 transmits the response signal with zero phase with respect to its local clock/oscillator (LO), the measured/determined phase φ₂₁ of the signal received at the first antenna unit 104 (at the receiving antenna 122) may be determined by:

φ₂₁=⊖_{C,2}−⊖_{T,2}−φ₂₁−⊖_{R,1}−⊖_{C,1}. (2)

⊖_{C,2} and ⊖_{C,1} are the phases of the local oscillators of the second and first radio units 110, 108, respectively (at the time of transmission for the second radio unit 110). ⊖₂₁ is the geometric phase corresponding to the distance or baseline or connecting geometric line between the transmission antenna 124 of the second antenna unit 106 and the receiving antenna 122 of the first antenna unit 104. ⊖_{T,2} and ⊖_{R,1} are the transmit and receive branch phase lengths corresponding to the first antenna unit 104 and second antenna unit 106, respectively.

The radio units may send the determined phase information (and possibly also other information, such as amplitude information) to a processor 102 (which may e.g. be incorporated with one of the radio units). The processor 102 may then determine a distance variable that is indicative of the distance d₁₂ between the first and second radio units 104, 106.

The distance variable may be determined as a sum of the received two-way phase information for a pair of antenna units for which two-way phase information has been received. In the example of FIG. 5 with a first 104 and second antenna unit 106, the distance variable V_{d} may be determined as:

V_{d}=φ₁₂+φ₂₁=⊖_{C,1}−⊖_{T,1}φ₁₂−⊖_{R,2}−⊖_{C,2}+⊖_{C,2}−⊖_{C,2}−φ₂₁−⊖_{R,1}−⊖_{C,1} (3)

The LO terms ⊖_{C,1} and ⊖_{C,2} cancel out, assuming that the LO phases have not drifted between the two transmissions (first signal and response signal). Therefore, the distance variable V_{d} may then be expressed as:

V_{d}=−⊖_{T,1}−φ₁₂−⊖_{R,2}−⊖_{T,2}−φ₂₁−⊖_{R,1} (4)

The distance variable determined as described herein is thus advantageously not dependent on the phase of the local oscillators of the radio units involved.

Possible frequency offset between local oscillators of radio units 108 and 110 can be easily measured from the determined phase information. The linear phase drift in V_{d} from such frequency offset can therefore be compensated for.

The distance variable may subsequently be determined a plurality of times (at least two times) through a plurality of measurement cycles. The processor 102 (or remote processor 112) may determine, based on the determined distance variables, if the distance variables indicates a change in the distance between the antenna units 104, 106. In particular, the processor 102 may determine of monitor the change occurring in determined distance variables for a specific pair of antennas between subsequent measurement cycles. This change ΔV_{d} may be determined as

ΔV_{d}=Δ(φ₁₂+φ₂₁)=Δ(−⊖_{T,1}−φ₁₂−⊖_{R,2}−⊖_{T,2}−φ₂₁−⊖_{R,1}) (5)

As may be easily understood by the skilled person, the phase difference Δφ between two points on a wave is given by 2π*Δx/λ, where λ is the wavelength and x is the distance between the two points. The change in the sum of the geometric phase corresponding to the distance or baseline or connecting geometric line between the transmission antenna 120 of the first antenna unit 104 and the receiving antenna 126 of the second antenna unit 106 is then given by

Δ(−φ₁₂−φ₂₁)=2*2π*Δd₁₂/λ, (6)

where Δd₁₂ is the change in distance between the antenna units 104, 106 (more specifically, the distance d₁₂ is the distance between the center point connecting the transmission antenna 120 of the first antenna unit 104 and the receiving antenna 122 of the first antenna unit 104 and the center point connecting the transmission antenna 124 of the second antenna unit 106 and the receiving antenna 126 of the second antenna unit 106, assuming that d₁₂ is much larger than the distance between the RX and TX elements within the antenna units 104, 106).

Therefore, the change in determined distance variable between measurement cycles may be given as

ΔV_{d}=4π*Δd₁₂/λ+Δ(−⊖_{T,1}−⊖_{R,2}−⊖_{T,2}−⊖_{R,1}). (7)

If the TX and RX branches (for instance transmission branch of TX1 or the transmission branch related to the transmission antenna of 120 of the first antenna unit 104, I_{T1}) can be assumed stable between measurements, the difference resulting from the instrumental terms, i.e. Δ(−⊖_{T,1}−⊖_{R,2}−⊖_{T,2}−⊖_{R,1}), can be assumed to be zero or negligible, so

ΔV_{d}≈4π*Δd₁₂/λ, (8)

If the measurement cycles are repeated frequently enough so that Δd₁₂<<λ/2 between measurement cycles, which may be easy to achieve with most large structures, such as bridges, the processor can compute Δd₁₂ (assuming that λ is known) and store it. Δd₁₂ may thus be determined by the processor and it may therefore be determined if a change occurs in the distance between the antenna units 104, 106 and the change in d₁₂ may be monitored with time.

If the instrumental terms in Equation 7 cannot be assumed to be stable, and their omission would lead to erroneous or inexact distance variables, in one advantageous embodiment of the invention, two-way calibration data may be determined in addition to the two-way phase information for a pair of antenna units. The two-way calibration data may comprise calibration phase information being indicative of a phase of a self-measurement signal received at a transmitting antenna unit during transmission of a signal. Determining of two-way calibration data according to an exemplary embodiment shown in FIG. 5 will be given below.

An (attenuated) sample of the first signal may be received at the receiving antenna 122 of the first antenna unit 104 as a self-measurement signal and the phase φ₁₁ of the received first signal as it reaches the receiving antenna 122 of the first antenna unit 104 may be determined by the first radio unit 108. The phase of the received signal may be determined/measured in the radio unit 108 with respect to the radio unit sampling clock or local oscillator of the radio unit 108.

According to FIG. 5 it may be determined that first calibration phase information indicative of the phase of the self-measurement signal may be given by

φ₁₁=−⊖_{T,1}−⊖_{TR,1}−⊖_{R,1}, (9)

where ⊖_{T,1} and ⊖_{R,1} are the transmit and receive branch phase lengths corresponding to the first antenna unit 104, respectively, and ⊖_{TR,1} is the phase of the signal transfer function between the transmission antenna 120 and receiving antenna 122 of the first antenna unit 104.

Accordingly, a sample of the response signal may be received at the receiving antenna 126 of the second antenna unit 106 as a self-measurement signal and the phase φ₂₂ of the received response signal as it reaches the receiving antenna 126 of the second antenna unit 106 may be determined by the second radio unit 110. The phase of the received signal may be determined/measured in the second radio unit 110 with respect to the radio unit sampling clock or local oscillator of the second radio unit 110.

Response calibration phase information indicative of the phase of the self-measurement signal at the second antenna unit 106 may be given by

φ₂₂=−⊖_{T,2}−⊖_{TR,2}−⊖_{R,2}, (10)

where ⊖_{T,2} and ⊖_{R,2} are the transmit and receive branch phase lengths corresponding to the second antenna unit 106, respectively, and ⊖_{TR,2} is the phase of the signal transfer function between the transmission antenna 124 and receiving antenna 126 of the second antenna unit 106.

The radio units 108, 110 may send the determined two-way phase information and two-way calibration data (comprising the calibration phase information) to the processor 102, and the processor 102 may in some embodiments determine the distance variable as being indicative of a difference between the sum of the two-way phase information obtained for each pair of antenna units and the sum of the two-way calibration data.

A distance variable may then be determined as (from Equations 4, 9, and 10):

V_{d}=φ₁₂+φ₂₁−φ₁₁−φ₂₂=−⊖_{T,1}−φ₁₂−⊖_{R,2}−⊖_{T,2}−φ₂₁−⊖_{R,1}+⊖_{T,1}+⊖_{TR,1}+⊖_{R,1}+⊖_{T,2}+⊖_{TR,2}+⊖_{R,2}. (11)

When it is assumed that the phase terms of the antenna units can be considered stable by way of design, the change in determined distance variable between measurement cycles may be determined as

ΔV_{d}=Δ(−φ₁₂−φ₂₁). (12)

Therefore, if two-way calibration data is determined, the change in distance variable between measurement cycles is directly indicative of the change in distance between the antenna units so that:

ΔV_{d}=4πr*Δd₁₂/λ, (13)

and the change in distance may be determined so that systematic errors caused by phase length changes in active components and/or antenna cables may be essentially eliminated.

The procedures above relating to FIG. 5 are easily implemented in arrangements with differing numbers of antenna units and radio units, as may be appreciated by the skilled person. For instance, also any of the arrangements 100, 200, 300 of FIGS. 1-3 may determine two-way calibration information. The arrangements may also operate without determining two-way calibration information.

If the number of antenna units is sufficiently large, e.g. 5 or more, it may be possible to compute a relative (Δx,Δy,Δz) vector for each antenna unit with respect to at least the first or master antenna unit. This can be accomplished by performing the phase measurements with signals having a plurality of different frequencies (at different measurement cycles) and finding a value for the distance variable that fulfills equation 11 at all measurement frequencies. Therefore, a three-dimensional mutual geometry of the antenna units may be measured and/or monitored, and e.g. changes occurring in the three-dimensional form of a structure may be determined and/or monitored.

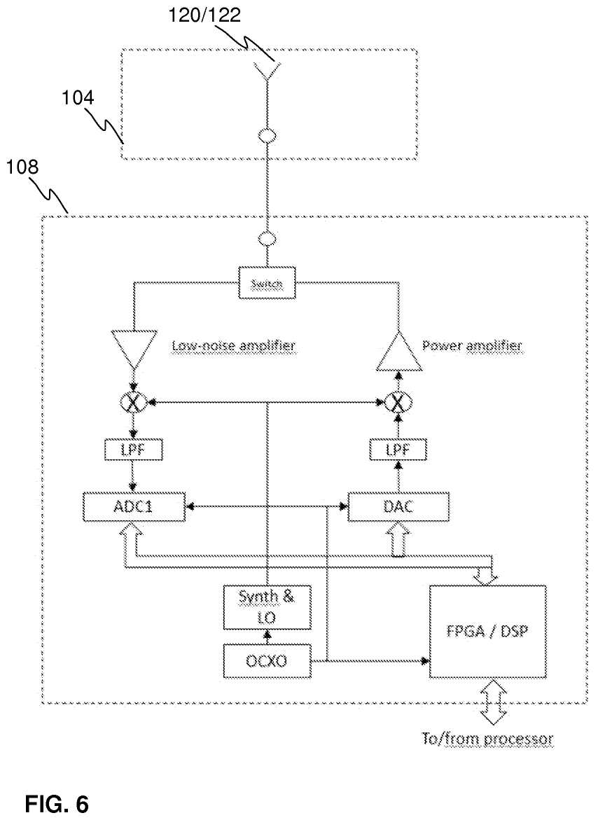

FIG. 6 gives one example of a radio unit 108 and associated antenna unit 104 that may be used in an arrangement according to one embodiment of the invention. The exemplary antenna units 104 given herein in the figures may in different embodiments of the invention be used either as master antenna units or as slave antenna units. The exemplary radio units 108 shown in the figures may also be used as either reference radio units or as other radio units comprised in the arrangement 100, 200, 300.

The radio unit 108 of FIG. 6 is associated with one antenna unit 104, which comprises one antenna 120/122 which may be used simultaneously as a transmitting antenna 120 (TX) and a receiving antenna 122 (RX).

The radio unit 108 of FIG. 6 is contemporary in its structure as may be understood by the skilled person, with e.g. switch, synthesizer (Synth), local oscillator (LO), field programmable gate array (FGPA), digital signal processor (DSP), digital-analog converter (DAC), analog-digital converter (ADC), oven-controlled crystal oscillator (OCXO), low pass filters (LPF), and amplifiers. Yet, one more benefit of the invention is that conventional or commercially readily available components, such as radio units and antenna units, may be employed.

A radio unit 108 may preferably be equipped with a sufficiently stable free-running oscillator in order to maintain accurate phase relationship within the measurement cycle and slot timing. Sufficiently stable could e.g. mean that the reference oscillator frequency during a measurement frame (duration of a signal, i.e., the time in which all participating nodes transmit their measurement signal, see FIG. 4) remains constant to such a degree that a resulting phase error of the local oscillator stays under e.g. 10 degrees, preferably for instance under 5 degrees.

The radio unit 108 and antenna unit 104 of FIG. 6 may be used in arrangements where calibration phase information is used or it may also be used in arrangements where calibration phase information is not used, i.e. two-way calibration data may or may not be utilized, whereby the antenna unit 104 or radio unit 108 may obtain information via a self-measurement if such information is to be used.

In the radio unit 108 of FIG. 6, if self-measurement is to be utilized, the calibration phase information is obtained through the self-measurement signal that “leaks” from the TX branch to the RX branch through the switch. In this embodiment, however, phase lengths of antenna cables cannot be taken into account with the calibration information, leaving some error due to this in the determined distance variable(s).

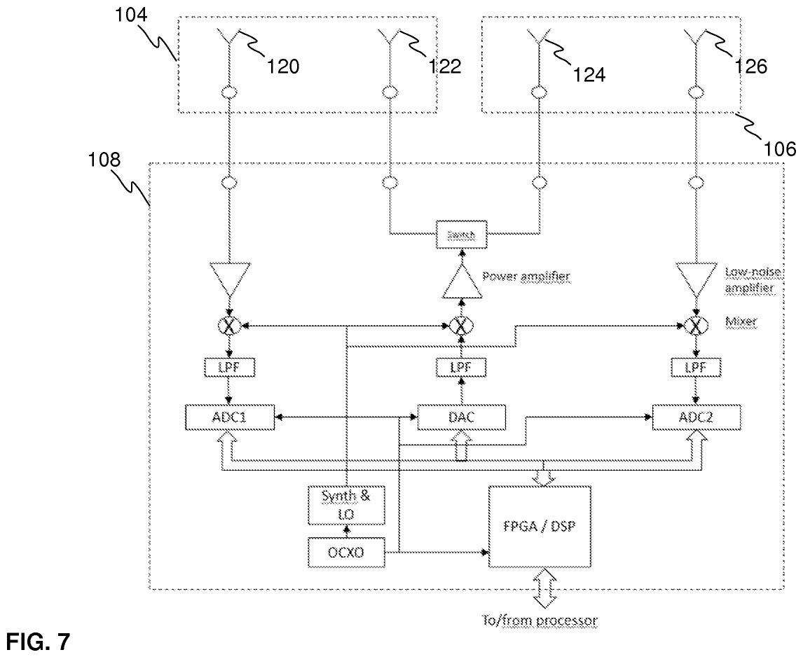

FIG. 7 gives one more exemplary radio unit 108 which may be used in arrangements according to different embodiments of the invention. In the embodiment of FIG. 7, the radio unit 108 is associated with two antenna units 104, 106. Both antenna units 104, 106 of FIG. 7 have separate transmission antennas 120, 124 and receiving antennas 124, 126. The structure and constituents of the radio unit 108 of FIG. 7 are again common in the state of the art.

The radio unit 108 of FIG. 7 may be used in arrangements where two-way calibration data is obtained and it may also be used in arrangements where two-way calibration data is not obtained. With the radio unit 108 of FIG. 7, if calibration phase information is determined, it may take into account also phase lengths of e.g. antenna cables and thus may lead to determined distance variables that are more accurate than with e.g. the radio unit 108 of FIG. 6.

FIG. 8 gives a portion of an exemplary antenna unit 104. Shown are the transmission antenna TX/120 and receiving antenna RX/122, with patch antennas 128 and patch substrate 130. The antenna unit may be provided with absorbing material 132. The symbol + at the center of a line connecting the transmission antenna TX and receiving antenna RX indicates the center point with respect to which a distance between the antenna unit 140 and another antenna unit in a pair of antenna units may be determined.

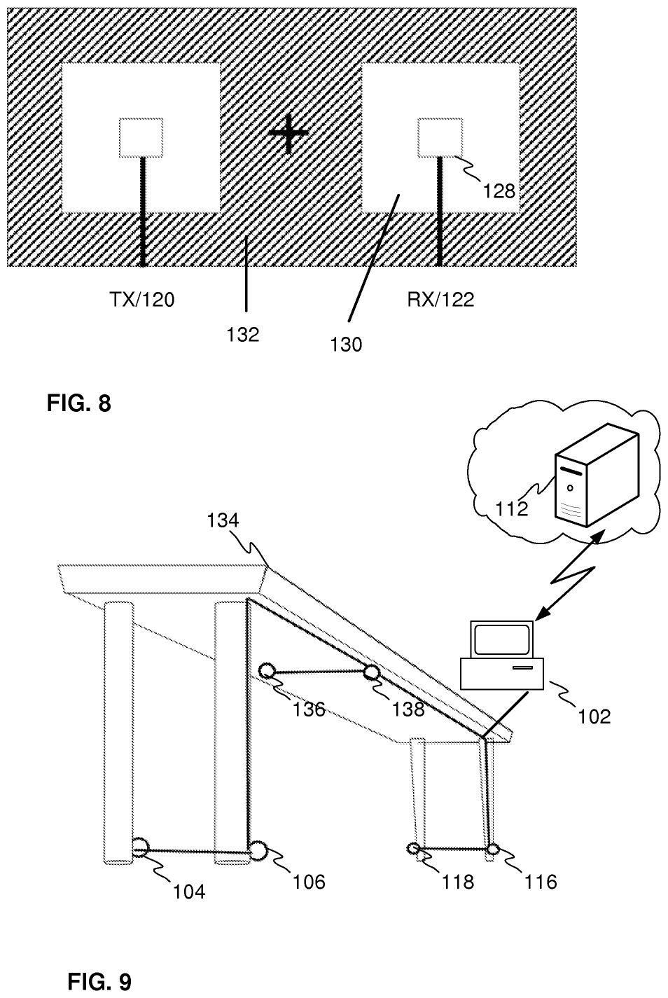

FIG. 9 illustrates schematically how an arrangement may be used in connection with a physical structure. A physical structure in FIG. 9 is a bridge 134, with a first antenna unit 104, second antenna unit 106, third antenna unit 116, fourth antenna unit 118, fifth antenna unit 136, and sixth antenna unit 138 being coupled to the bridge 134 at first, second, third, fourth, fifth, and sixth locations. Advantageously, some of the locations, e.g. first and second locations for first antenna unit 104 and second antenna unit 106 may be considered to be locations which are relatively stationary at least compared to other locations associated with the structure that may be expected to show movement over time.

For instance, in the embodiment of FIG. 9, radio units being associated with two antenna units each may be employed, such that first and second antenna units 104 and 106 are associated with a first radio unit, third and fourth antenna units 116 and 118 are associated with a second radio unit, and fifth and sixth antenna units 136, 138 are associated with a third radio unit.

In the embodiment of FIG. 9, e.g. up to 15 pairs of antenna units could determine two-way phase information and possibly two-way calibration data to determine up to 15 distance variables, which could be monitored during a plurality of measurement cycles.

The arrangement of FIG. 9 comprises also a processor 102, which could for instance be comprised in a personal computer-type apparatus that is located at or near the physical structure. The processor 102 may control the radio units (and antenna units) and receive data from the radio units. The processor 102 may also perform calculation or determination of e.g. distance variables and may additionally determine distances and/or three-dimensional geometry and changes in the distances and/or three dimensional geometries that are observed through the measurement cycles.

A processor 102 may be in communication with a remote processor 112, which may store any data that is received from the processor 102. The remote processor 112 (or in some embodiments additionally or alternatively also the processor 102) may for instance also provide means for visualization of the performed monitoring of the physical structure. For example, the bridge 134 may be monitored over time through the apparatus of FIG. 9 and it may be possible to provide a visualization of a change in physical form of the bridge that is determined over time through the measurements.

A processor 102 and/or remote processor 112 may provide means for analysis of the obtained and/or determined data. The analysis may be indicative of e.g. future predictions in deformation of physical structures based on the performed measurements. For example, future predictions could comprise the physical condition of the bridge, estimated safe lifetime and/or estimated time before major repair.

A processor 102 and/or remote processor 112 may in some embodiments be used for configuration of an arrangement 100, 200, 300.

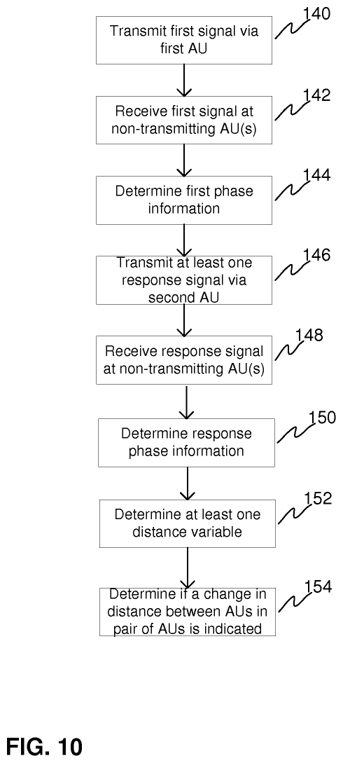

A flow chart of a method according to one embodiment of the invention is shown in FIG. 10. At least one first signal is transmitted 140 via at least one first antenna unit (AU). The first antenna unit 104 may be configured to be placed at a first location. The first signal is received 142 at at least one non-transmitting antenna unit 106, 116, 118 e.g. at at least a second antenna unit 106, which may be configured to be placed at a second location. First phase information is determined 144, where the first phase information is indicative of a phase of the received first signal with respect to a local oscillator of a radio unit with which the at least one second antenna unit is associated with.

At least one response signal is transmitted 146 via the second antenna unit 106, said response signal being received by non-transmitting antenna units, comprising at least the first antenna unit 104. Response phase information is determined 150, said response phase information being indicative of a phase of the received response signal with respect to a local oscillator of the radio unit with which the at least one first antenna unit is associated.

In some embodiments, the transmitting of response signals 146 comprises transmitting of response signals via a plurality of antenna units one at a time and in a predetermined order, each antenna unit transmitting a response signal in its predetermined time slot. The response signal should essentially correspond to the first signal, i.e. at least have a same frequency as the first signal.

At least one pair of antenna units is thus obtained that have mutually transmitted and received at least one signal among each other so that two-way phase information is determined with respect to at least one signal that is sent by a first antenna unit in the pair of antenna units and received by the second antenna unit in the pair of antenna units and at least one signal that is sent by the second antenna unit in the pair of antenna units and received by the first antenna unit in the pair of antenna units.

At least one distance variable may then be determined 152, said distance variable being indicative of a distance between the antenna units 104, 106, 116, 118, 136, 138 in the at least one pair of antenna units. The distance variable may be indicative of sums of the two-way phase information obtained for each pair of antenna units. At least a first distance variable may be indicative of a distance between the first and second antenna units and the first distance variable may optionally be indicative of a sum of the first phase information and the response phase information.

The method items 140-152 constitute a measurement cycle and are repeated at least once, so that at least two measurement cycles are performed. Based on the repeatedly determined distance variable(s), it is determined at 154 if the distance variable(s) indicate a change in the distance between the antenna units in the at least one pair of antenna units.

The repeatedly determined distance variable(s) may be used to monitor the distance between antenna units. The monitoring of distance may subsequently be utilized in various applications.

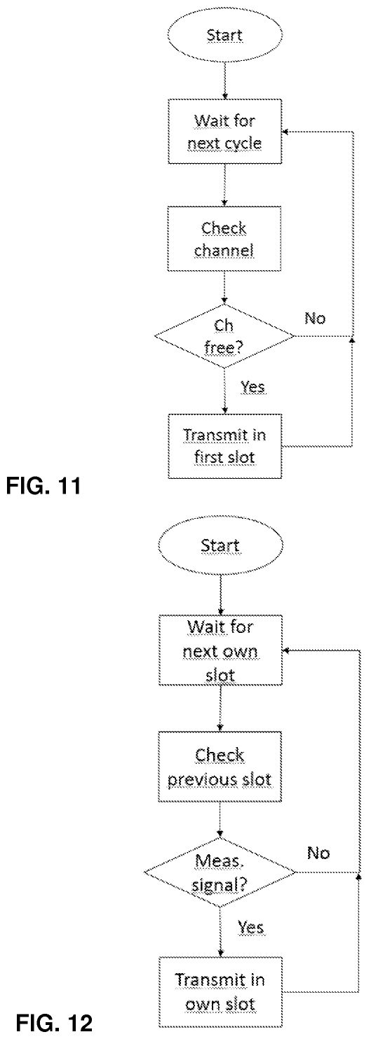

FIG. 11 illustrates a portion of a flow chart of a method according to one embodiment of the invention. The method items of FIG. 11 may be associated with a first antenna unit 104 in one embodiment of the invention, where the first antenna unit 104 may be designated as a master antenna unit an is configured to perform an inquiry or check related to a transmission channel that is intended to be used for transmission of signals.

At the beginning of each measurement cycle (or before the start of a measurement cycle, before any sending of signals via antenna units), the first antenna unit 104 may check e.g. via its receiving antenna, if the transmission channel is occupied (if a transmission is already occurring). If the channel is occupied, the first antenna unit may not transmit a first signal, while if the channel is free, the first signal may be transmitted by the first antenna unit 104, and the measurement cycle may be commenced with. If the channel has been deemed to be occupied and the first signal is not transmitted, the measurement cycle will thus not be initiated and the first antenna unit 104 may then wait for a predetermined time interval between measurement cycles until yet once again carrying out the checking of the transmission channel.

FIG. 12 shows a portion of a flow chart of a method according to one embodiment of the invention. The method items of FIG. 12 may be associated with one or more slave antenna units 106, 116, 118, 136, 138 in cases where one other antenna unit has been deemed as a master antenna unit.

A slave antenna unit AU_{N} may wait, at each measurement cycle, until its own predetermined time slot for transmission of a signal occurs. At the beginning of this time slot, the antenna unit AU_{N} may check if the previous antenna unit in the measurement cycle AU_{N-1} has transmitted its respective signal, i.e., antenna unit AU_{N} will determine if a signal transmitted by AU_{N-1} has been received at the receiving antenna of AU_{N}. If such signal has been received and thus measured, the antenna unit AU_{N} will continue the measurement cycle by transmitting its own signal, while if the signal from AU_{N-1} has not been received, AU_{N} will not transmit a signal, and the measurement cycle is not continued.

The invention has been explained above with reference to the aforementioned embodiments, and several advantages of the invention have been demonstrated. It is clear that the invention is not only restricted to these embodiments, but comprises all possible embodiments within the spirit and scope of inventive thought and the following patent claims.

The features recited in dependent claims are mutually freely combinable unless otherwise explicitly stated.

1. An arrangement for monitoring of at least one distance between antenna units, the arrangement comprising at least two antenna units, each antenna unit being associated with a radio unit, the arrangement additionally comprising at least one radio unit being associated with at least one of the at least two antenna units, and at least one processor, the two antenna units being configured to be placed at at least first and second locations, the arrangement being configured to
a) execute at least two measurement cycles wherein during each measurement cycle the arrangement is configured to
i. transmit at least a first signal via at least one first antenna unit,
ii. receive the at least first signal at at least one second antenna unit,
iii. determine at least first phase information related to the first signal, said first phase information being indicative of a phase of the received first signal with respect to a local oscillator of the radio unit with which the at least one second antenna unit is associated,
iv. transmit at least one response signal via the at least one second antenna unit, wherein the response signal essentially corresponds to the first signal,
v. receive the at least one response signal at the at least one first antenna unit,
vi. determine at least response phase information related to the response signal, said response phase information being indicative of a phase of the received response signal with respect to a local oscillator of the radio unit with which the at least one first antenna unit is associated, to obtain at least one pair of antenna units which have mutually transmitted and received at least one signal among each other so that two-way phase information is determined with respect to at least one signal that is sent by a first antenna unit in the pair of antenna units and received by the second antenna unit in the pair of antenna units and at least one signal that is sent by the second antenna unit in the pair of antenna units and received by the first antenna unit in the pair of antenna units,
vii. determine at least one distance variable, said distance variable being indicative of a distance between the antenna units in the at least one pair of antenna units, the distance variable optionally being indicative of sums of the two-way phase information obtained for each pair of antenna units, an at least first distance variable being indicative of a distance between the first and second antenna units, the first distance variable optionally being indicative of a sum of the first phase information and the response phase information,
b) determine, based on the determined at least one distance variable at each measurement cycle, a change in the distance (d₁₂) between the antenna units in at least one pair of antenna units.

2. The arrangement of claim 1, wherein if a change in distance between antenna units in at least one pair of antenna units is indicated according to predetermined criteria, initiate an action, said action optionally comprising providing an indication to a user of the arrangement that a distance between antenna units in at least one pair of antenna units has changed.

3. The arrangement of claim 1, wherein the arrangement comprises a plurality of antenna units, each antenna unit being associated with a radio unit, wherein during each measurement cycle, the arrangement is configured to
a) transmit at least a first signal via at least one first antenna unit,
b) receive the at least first signal at the remaining non-transmitting antenna units,
c) determine, respectively for each non-transmitting antenna unit receiving the first signal, at least first phase information related to the first signal, said first phase information being indicative of a phase of the received first signal with respect to a local oscillator of the radio unit with which the receiving non-transmitting antenna unit is associated,
d) transmit a plurality of response signals via at least a portion of the antenna units that have not transmitted the first signal, wherein the response signals essentially correspond to the first signal, wherein the response signals are transmitted consecutively by one antenna unit at a time, via at least a portion of the antenna units that have not transmitted the first signal,
e) receive the plurality of response signals at at least a portion of the remaining non-transmitting antenna units,
f) determine, respectively for each non-transmitting antenna unit receiving the response signals, at least response phase information related to each of the received response signals, said response phase information being indicative of a phase of the received response signal with respect to a local oscillator of the radio unit with which the remaining non-transmitting antenna units receiving the response signal are associated with,
g) transmit response signals, receive response signals, and determine phase information to obtain a plurality of pairs of antenna units, which have mutually transmitted and received at least one signal among each other so that two-way phase information is determined with respect to at least one signal that is sent by a first antenna unit in the pair of antenna units and received by the second antenna unit in the pair of antenna units and at least one signal that is sent by the second antenna unit in the pair of antenna units and received by the first antenna unit in the pair of antenna units, and
h) determine at least a plurality of distance variables, each distance variable being indicative of a distance between the antenna units in each pair of antenna units, the distance variables optionally being indicative of sums of the two-way phase information obtained for each pair of antenna units.

4. The arrangement of claim 1, wherein each of the transmitting antenna units transmits at least one signal within a predetermined time slot and preferably in predetermined order, further wherein transmissions preferably occur in subsequent time slots so that no empty time slots are left between the transmissions, where a time interval between the end of a transmission and the start of a subsequent transmission is less than 16 μs.

5. The arrangement of claim 1, wherein the first antenna unit is a master unit and the remaining antenna units are slave units, the master unit being configured to transmit the first signal, wherein the master unit is configured to check before transmission of the first signal at each measurement cycle whether a radio channel is free for transmission and if the channel is free, the at least first signal is transmitted, said transmitting not being executed if the channel is not free, further wherein the at least first antenna unit optionally sends a time synchronization signal that is received by the remaining antenna units before sending of the first signal.

6. The arrangement of claim 5, wherein the slave units are configured to determine, before transmitting of a signal in a given measurement cycle, if a previous antenna unit in the predetermined order of antenna units has transmitted a signal in the measurement cycle, and if yes, transmit their respective signal, while the signal is not transmitted if it is determined that the previous antenna unit has not transmitted a signal.

7. The arrangement of claim 1, wherein the arrangement is additionally configured to determine two-way calibration data for at least one of said pairs of antenna units, wherein the two-way calibration data is indicative of a self-measurement signal received at a transmitting antenna unit during transmission of a signal, for each of the two antenna units in the pair of antenna units, further wherein the arrangement is configured to determine said at least one distance variable as being indicative of a difference between the sum of the two-way phase information obtained for each pair of antenna units and the sum of the two-way calibration data.

8. The arrangement of claim 7, wherein the two-way calibration data comprises calibration phase information for each of the antenna units in the pair of antenna units, said calibration phase information being indicative of a phase of a self-measurement signal with respect to the local oscillator of a radio unit with which the transmitting antenna unit is associated.

9. The arrangement of claim 1, wherein at least one radio unit is associated with at least two antenna units.

10. The arrangement of claim 1, wherein the arrangement comprises at least five antenna units, the arrangement being configured to monitor, based on the determined distance variables, changes in the three-dimensional geometry of the at least five antenna units.

11. The arrangement of claim 1, wherein the arrangement additionally comprises at least one remote processor configured to receive at least data indicative of the determined distance variables.

12. The arrangement of claim 1, wherein the first signal is an unmodulated radiofrequency signal, a comb of sinusoids spanning a selected radiofrequency range, or a radiofrequency signal modulated by a selected sequence.

13. The arrangement of claim 1, wherein the arrangement is configured to essentially continuously monitor the at least one distance by executing measurement cycles at predetermined time intervals.

14. The arrangement of claim 1, wherein the arrangement is additionally configured to communicate data and multiplex the data and the signals transmitted via the antenna units in time or frequency domain, wherein the data preferably comprises at least the determined phase information.

15. A method for monitoring at least one distance between antenna units, the method comprising
a) execution of at least two measurement cycles wherein each measurement cycle comprises
i. transmitting at least a first signal via at least one first antenna unit, said first antenna unit being configured to be placed at a first location,
ii. receiving the at least first signal at at least one second antenna unit, said second antenna unit being placed at a second location,
iii. determining at least first phase information related to the first signal, said first phase information being indicative of a phase of the received first signal with respect to a local oscillator of a radio unit with which the at least one second antenna unit is associated with,
iv. transmitting at least one response signal via the at least one second antenna unit, wherein the response signal essentially corresponds to the first signal,
v. receiving the at least one response signal at the at least one first antenna unit,
vi. determining at least response phase information related to the response signal, said response phase information being indicative of a phase of the received response signal with respect to a local oscillator of a radio unit with which the at least one first antenna unit is associated, to obtain at least one pair of antenna units which have mutually transmitted and received at least one signal among each other so that two-way phase information is determined with respect to at least one signal that is sent by a first antenna unit in the pair of antenna units and received by the second antenna unit in the pair of antenna units and at least one signal that is sent by the second antenna unit in the pair of antenna units and received by the first antenna unit in the pair of antenna units,
vii. determining at least one distance variable, said distance variable being indicative of a distance between the antenna units in the at least one pair of antenna units, the distance variable optionally being indicative of sums of the two-way phase information obtained for each pair of antenna units, an at least first distance variable being indicative of a distance between the first and second antenna units, the distance variable optionally being indicative of a sum of the first phase information and the response phase information,
b) determining, based on the determined at least one distance variable at each measurement cycle, a change in the distance between the antenna units in at least one pair of antenna units.

16. The method of claim 15, wherein the method comprises, at each measurement cycle,
a) transmitting at least a first signal via at least one first antenna unit,
b) receiving the at least first signal at the remaining non-transmitting antenna units,
c) determining, respectively for each non-transmitting antenna unit receiving the first signal, at least first phase information related to the first signal, said first phase information being indicative of a phase of the received first signal with respect to a local oscillator of the radio unit with which the receiving non-transmitting antenna unit is associated,
d) transmitting a plurality of response signals via at least a portion of the antenna units that have not transmitted the first signal, wherein the response signals essentially correspond to the first signal, wherein the response signals are transmitted consecutively by one antenna unit at a time, via at least a portion of the antenna units that have not transmitted the first signal,
e) receiving the plurality of response signals at at least a portion of the remaining non-transmitting antenna units,
f) determining, respectively for each non-transmitting antenna unit receiving the response signals, at least response phase information related to each of the received response signals, said response phase information being indicative of a phase of the received response signal with respect to a local oscillator of the radio unit with which the remaining non-transmitting antenna units receiving the response signal are associated with,
g) transmitting response signals, receive response signals, and determine phase information to obtain a plurality of pairs of antenna units, which have mutually transmitted and received at least one signal among each other so that two-way phase information is determined with respect to at least one signal that is sent by a first antenna unit in the pair of antenna units and received by the second antenna unit in the pair of antenna units and at least one signal that is sent by the second antenna unit in the pair of antenna units and received by the first antenna unit in the pair of antenna units, and
h) determining at least a plurality of distance variables, each distance variable being indicative of a distance between the antenna units in each pair of antenna units, the distance variables optionally being indicative of sums of the two-way phase information obtained for each pair of antenna units.

17. The method of claim 15, wherein the transmitting of the each of the signals is carried out within a predetermined time slot and preferably in predetermined order, further wherein transmitting preferably occurs in subsequent time slots so that no empty time slots are left between the transmissions, where a time interval between the end of a transmission and the start of a subsequent transmission is less than 16 μs.

18. A computer program comprising program code means adapted to execute the method items of claim 15 when the program is run on a computer.

19. Use of an arrangement according to claim 1 for monitoring at least one physical structure, such as a bridge, roof, skyscraper or other building, wind turbine or wind turbine blade, smoke stack, mast, dam, crane, tunnel, pipeline or storage tank, support structure of heavy machinery, or alignment of long axles, wherein the two or more antenna units are operatively coupled to said structure(s) at at least first and second locations.
